(19) United States
(12) Patent Application Publication
(10) Pub. No.: US 2009/0058376 A1
(43) Pub. Date: Mar. 5, 2009

(54) EQUIPMENT CONTROL ARRANGEMENT SUITABLE FOR PROVIDING INFORMATION ABOUT AN OPERATING STATE OF THE EQUIPMENT

(75) Inventor: Remi Sigrist, Mery Sur Oise (FR)

Correspondence Address: FOLEY & LARDNER LLP, 777 EAST WISCONSIN AVENUE, MILWAUKEE, WI, 53202-5306, US

(73) Assignee: JOHNSON CONTROLS TECHNOLOGY COMPANY, Holland, MI (US)

(21) Appl. No.: 11/661,331

(22) PCT Filed: Aug. 25, 2005
(86) PCT No.: PCT/FR2005/002139

§ 371 Date: Oct. 22, 2008

(30) Foreign Application Priority Data
Aug. 27, 2004 (FR) 0409134

(51) Int. Cl. G05F 1/10

(52) U.S. Cl. 323/234

(57) ABSTRACT

A control circuit is provided for controlling a vehicle component (e.g., an HVAC system). The control circuit includes a communication link that connects the equipment control module to the control assembly and communicates instructions from the control assembly to the equipment control module and performance characteristics from the vehicle component to the control assembly.

### CROSS-REFERENCE TO RELATED PATENT APPLICATIONS

The present Application is a National Stage of Application PCT/FR2005/002139 entitled, “An Equipment Control Arrangement Suitable for Providing Information About an Operating State of the Equipment” filed on Aug. 25, 2005, which published under PCT Article 21(2) on Mar. 16, 2006 as WO2006/027462 in the French language, which claims priority to French Patent Application No. FR 0409134 filed on Aug. 27, 2004, the disclosures of which are incorporated herein by reference in their entirety.

### TECHNICAL FIELD

The present application relates to an equipment control arrangement suitable for providing information about an operating state of the equipment. This application applies in particular to a control arrangement for controlling fan equipment in a car air-conditioner unit.

### BACKGROUND

Numerous pieces of equipment, in particular for cars, are known that are controlled by a centralized control unit that provides coordinated management of the various pieces of equipment. For this purpose, the control unit is connected via a connection wire to a control module specific to each piece of equipment. The connection wire serves to transmit a setpoint signal from the control unit to the control module of the equipment.

In order to provide coordinated management, the centralized control unit needs to receive information about the operating state of various pieces of equipment. For example, a car air-conditioner unit includes a refrigerator circuit comprising a compressor, a condenser, and an evaporator, with the condenser being cooled by fan equipment. To control the compressor, it is important to know the operating state of the condenser fan equipment in order to avoid keeping the compressor in operation if the condenser is not being cooled by the fan equipment.

To transmit information about the state of the various pieces of equipment to the centralized control unit, it is known to use arrangements comprising a member for detecting different operating states, and a multi-frequency signal generator for generating an information signal at a frequency corresponding to the detected operating state. The information signal is conveyed by the connection wire and is analyzed in the control unit to deduce therefrom the operating state of the equipment. Nevertheless, members for generating and analyzing multi-frequency signals are relatively expensive. In addition, analyzing frequencies in a range requires a length of time that increases with increasing number of distinct frequencies.

Some devices transmit information by adding additional connection wires between the central unit and the equipment control module, each connection wire corresponding to one particular operating state. Information about each operating state can thus be transmitted immediately.

Nevertheless, installing multiple connection wires for each piece of equipment significantly increases the overall cost of installing wire harnesses and of connecting said wire harnesses both to the pieces of equipment and to the control unit.

### SUMMARY

Provided is an equipment control arrangement enabling information to be transmitted simply and quickly about the operating state of the equipment.

One exemplary embodiment relates to an arrangement for controlling a piece of equipment. The arrangement includes a control assembly having a control unit for generating a control setpoint that is transmitted via a connection wire to a control and detector member of a control module of the equipment. The control assembly includes a current generator controlled by the control setpoint to deliver a current setpoint signal over the connection wire. The control module of the equipment includes a variable load connected to the connection wire in parallel with the control and detector member. The variable load has a magnitude that is controlled by the control and detector member, and the control unit includes a voltage sensor connected to the connection wire and a calculator member for calculating the load from the control setpoint and an output signal from the voltage sensor.

Another exemplary embodiment relates to a control assembly for a vehicle component that includes a control setpoint for receiving and/or designating a performance parameter for the vehicle component and a load calculator member, which is connected to the control setpoint and configured to receive the performance parameter. A voltage sensor is connected to the vehicle component and configured to measure the load on the vehicle component. A connection wire is coupled to the control assembly and the vehicle component. The connection wire is configured to measure a performance parameter for the vehicle component and the connection wire is configured to send a designation for a performance parameter from the control assembly to the vehicle component.

In another exemplary embodiment relates to a method of controlling a piece of vehicle equipment. The method includes receiving a setpoint value for a performance characteristic of the vehicle component; and sending the setpoint value to an equipment control module. The equipment control module is configured to control the vehicle component and the setpoint value is sent over a connection wire. The method further includes measuring the performance characteristic with respect to the vehicle component through the connection wire.

### BRIEF DESCRIPTION OF THE DRAWING

Other characteristics and advantages of the invention appear on reading the following description of a particular, non-limiting embodiment of the invention, with reference to the FIGURES:

FIG. 1 is a schematic illustration of a control arrangement according to an exemplary embodiment.

### DETAILED DESCRIPTION

The application provides an arrangement for controlling a piece of equipment, the arrangement comprising a control assembly having a control unit for generating a control setpoint that is transmitted via a connection wire to a control and detector member of a control module of the equipment, wherein the control assembly includes a current generator controlled by the control setpoint to deliver a current setpoint signal over the connection wire, the control module of the equipment includes a variable load connected to the connection wire in parallel with the control and detector member, the variable load having a magnitude that is controlled by the control and detector member, and the control unit includes a voltage sensor connected to the connection wire and a calculator member for calculating the load from the control setpoint and an output signal from the voltage sensor.

Thus, the connection wire serving initially for transmitting the control setpoint is also used for transmitting information about the operating state of the equipment, such that the number of connection wires and the number of connections remains unchanged. In addition, the components added to the control unit and to the control module of the equipment are very inexpensive components, such that information about the operating state of the equipment is transmitted at smaller cost.

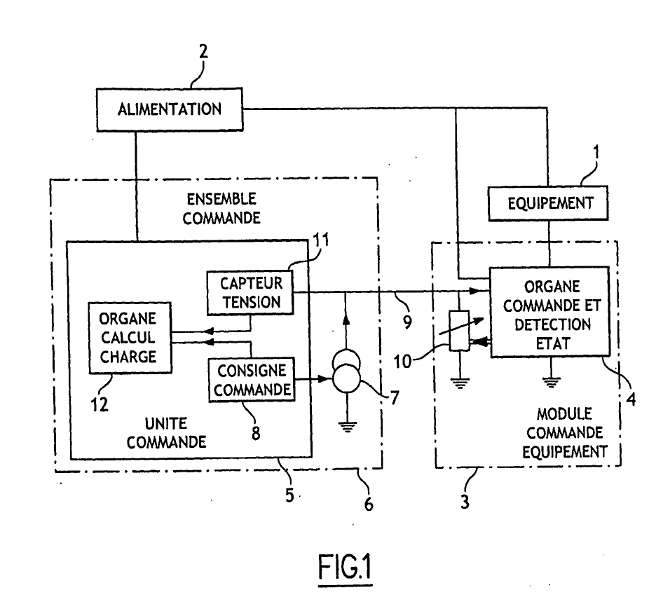

With reference to FIG. 1, a piece of equipment 1, e.g. fan equipment for a car air-conditioner unit (not shown) is connected to a power supply 2, e.g. the battery of a vehicle. The current passing through the equipment 1 is controlled by a control module 3 that is also connected to the power supply 2, and that comprises a member 4 for controlling the equipment 1 and for detecting an operating state of the equipment 1. The control module 3 is connected in conventional manner by a connection wire 9 to a control unit 5 of a control assembly 6.

According to the invention, the control assembly 6 includes a current generator 7 that receives the control setpoint 8 generated by the control unit 5, and transforms it into a current control setpoint that is transmitted over the connection wire 9. This current control setpoint is received by the control module 3 of the equipment, and is used in conventional manner for regulating the operation of the equipment 1.

According to a second characteristic, the control module 3 of the equipment 1 includes a variable load 10 that is connected to the connection wire 9 in parallel with the control and detector member 4. The magnitude of this variable load is controlled by the control and detector member 4 as a function of the operating state of the equipment. In practice, the variable load 10 presents a resistance varying over the range 1 kilohms (kΩ) to 10 kΩ, with a number of intermediate values that varies as a function of the number of operating states that it is desired to transmit to the control unit.

According to a third characteristic, the control unit 5 includes a voltage sensor 11 connected to the connection wire 9. The output from the voltage sensor 11 is connected to an input of a calculator member 12 having a second input receiving the current control setpoint 8. The calculator member can thus determine the resistance of the variable load 10 merely by applying Ohm's law V=IR, and can deduce therefrom the operating state of the equipment 1.

Naturally, the invention is not limited to the embodiment described and variant embodiments can be applied thereto without going beyond the ambit of the invention as defined by the claim. In particular, although the current generator 7 is shown as being outside the control unit 5, while the voltage sensor 11 as being integrated in the control unit, the physical disposition of these components depends essentially on the arrangement desired when designing the printed circuit cards that generally make up the control assembly, the control unit, and the equipment control module.

1. (canceled)

2. An arrangement for controlling a piece of equipment, the arrangement comprising a control assembly having a control unit for generating a control setpoint that is transmitted via a connection wire to a control and detector member of a control module of the equipment, wherein the control assembly includes a current generator controlled by the control setpoint to deliver a current setpoint signal over the connection wire, the control module of the equipment includes a variable load connected to the connection wire in parallel with the control and detector member, the variable load having a magnitude that is controlled by the control and detector member, and the control unit includes a voltage sensor connected to the connection wire and a calculator member for calculating the load from the control setpoint and an output signal from the voltage sensor.

3. An arrangement for controlling a piece of equipment, the arrangement comprising:
a control assembly having a control unit for generating a control setpoint, the control setpoint transmittable via a connection wire connected to a control-detector member of a control module of the equipment;
wherein the control assembly includes a current generator controlled by the control setpoint and configured to deliver a current setpoint signal over the connection wire,
wherein the control module includes a variable load connected to the connection wire in parallel with the control-detector member;
wherein the variable load is configured to provide a voltage with a magnitude that is controlled by the control-detector member; and
wherein the control unit includes a voltage sensor connected to the connection wire and a calculator member for calculating the load from the control setpoint and an output signal from the voltage sensor.

4. The arrangement of claim 3, wherein the piece of equipment is a heating, ventilation and cooling system for a motor vehicle.

5. The arrangement of claim 3, wherein the connection wire is connected in parallel with the control-detector member.

6. The arrangement of claim 3, wherein the variable load presents a resistance between 1 kilohm and 10 kilohms.

7. The arrangement of claim 3, wherein the calculator member is configured to determine the resistance of the variable load by dividing the load applied by a measured current.

8. The arrangement of claim 3, wherein the current generator is integrated in the control unit.

9. The arrangement of claim 3, wherein the current generator is located outside of the control unit.

10. A control assembly for a vehicle component, comprising:
a control setpoint for receiving and/or designating a performance parameter for the vehicle component;
a load calculator member, connected to the control setpoint and configured to receive the performance parameter;
a voltage sensor connected to the vehicle component, configured to measure the load on the vehicle component; and
a connection wire coupled to the control assembly and the vehicle component, wherein the connection wire is configured to measure a performance parameter for the vehicle component and wherein the connection wire is configured to send a designation for a performance parameter from the control assembly to the vehicle component.

11. The control assembly of claim 10, further comprising:
a variable load connected to the connection wire configured to govern the amount of voltage received by the vehicle component from a vehicle power source.

12. The control assembly of claim 11, wherein the variable load presents a resistance between 1 kilohm and 10 kilohms.

13. The control assembly of claim 11, wherein the calculator member is configured to determine the resistance of the variable load.

14. The control assembly of claim 13, wherein the calculator member is configured to determine the resistance of the variable load by dividing the load applied by a measured current.

15. The control assembly of claim 11, wherein the vehicle component is a heating, ventilation and cooling system for a motor vehicle.

16. The control assembly of claim 10, further comprising a control-detector member, configured to monitor the performance of the vehicle component.

17. The control assembly of claim 16, wherein the connection wire is connected in parallel with the control-detector member.

18. The control assembly of claim 16, further comprising:
a variable load connected to the connection wire configured to govern the amount of voltage received by the vehicle component from a vehicle power source;
wherein the variable load is configured to provide a voltage that is controlled by the control-detector member.

19. The control assembly of claim 10, further comprising:
a current generator coupled to the control setpoint and configured to deliver a current setpoint signal over the connection wire.

20. The control assembly of claim 19, wherein the current generator is integrated in the control assembly.

21. The control assembly of claim 19, wherein the current generator is located outside of the control assembly.

22. A method of controlling a piece of vehicle equipment, comprising:
receiving a setpoint value for a performance characteristic of the vehicle component;
sending the setpoint value to an equipment control module, the equipment control module configured to control the vehicle component, wherein the setpoint value is sent over a connection wire; and
measuring the performance characteristic with respect to the vehicle component through the connection wire.
